(19) United States
(12) Patent Application Publication
(10) Pub. No.: US 2006/0169947 A1
(43) Pub. Date: Aug. 3, 2006

(54) Deicing compositions and methods of use

(76) Inventor: E. G. Leist, Lakewood, CO (US)

Correspondence Address: SHERIDAN ROSS PC, 1560 BROADWAY, SUITE 1200, DENVER, CO, 80202, US

(21) Appl. No.: 11/375,368

(22) Filed: Mar. 13, 2006

Related U.S. Application Data
(63) Continuation-in-part of application No. 11/040,719, filed on Jan. 21, 2005.
Application No. 11/040,719 is a division of application No. 10/384,177, filed on Mar. 6, 2003, now Pat. No. 6,861,009.

(51) Int. Cl. C09K 3/18; C04B 9/02

(52) U.S. Cl. 252/70; 106/2; 106/13; 106/14.05; 106/14.25; 106/14.22; 106/14.44; 106/14.41

(57) ABSTRACT

The invention provides a non-corrosive deicing composition containing a deicing component, a corrosion inhibitor and a protein component. The invention also provides corrosion-inhibiting compositions containing digested proteins. The invention also provides methods of removing snow and ice from a surface by applying these deicing compositions to the ice or snow.

### CROSS REFERENCE TO RELATED APPLICATION

This application is a continuation-in-part of U.S. patent application Ser. No. 11/040,719, filed Jan. 21, 2005, which is a divisional of U.S. patent application Ser. No. 10/384,177, now U.S. Pat. No. 6,861,009 filed Mar. 6, 2003. Both of these previous applications are incorporated in their entirety by this reference.

### FIELD OF THE INVENTION

The invention lies in the field of deicing and corrosion-inhibiting compositions suitable for making surfaces free of snow and ice without promoting the corrosion of metal surfaces, and to methods of using these compositions.

### BACKGROUND OF THE INVENTION

Most northern cities incur considerable yearly expense in the removal of snow and ice from streets and other outdoor surfaces to meet the winter time needs of business, industry, and the public in general. Reliance on mechanical means of snow or ice removal alone, however, is insufficient, necessitating the use of deicing salts. Rock salt or sodium chloride is the most common chemical used for deicing, primarily because of its low cost, ease of transportation, and readily dispersible form.

The cost of the prior art deicing salts, including sodium chloride, calcium chloride, magnesium chloride, or rock salt, are deceptively low given the unassumed cost of corrosion to metal guardrails, bridge supports, metal concrete reinforcing rods and automobiles that come in contact with these salts. As such, these chemicals ultimately cost the public far more in corrosion damage than the initial material cost would indicate. In order to overcome these corrosive properties, chemicals such as ammonium sulfate, ammonium nitrate, ammonium chloride, urea, alcohols and glycols have been tested as replacements for the corrosive salts. While these chemicals reduce corrosion, they are more expensive, difficult to apply and carry hidden costs in the form of environmental pollution and toxic properties.

In searching for chemicals that can be used to melt ice and snow without causing corrosion or pollution, the preferable chemicals should have suitable water solubility, be inexpensive to produce on an industrial scale and be applicable by generally known means and equipment. For these reasons, many deicing compositions have been proposed that contain protein from food, beverage or agricultural waste streams. For example, deicing compositions have been proposed that contain by-products from the production of cheese and milks, waste concentrates from the alcohol distilling industry, byproducts of sulfite pulp mills, solubles that settle during the fermentation of wines, and the like. These compositions also contain corrosive salts but the protein sources appear to reduce the corrosive effects of the salts while maintaining the ice- and snow-melting properties. Additionally, the protein components reduce the need for additional corrosion inhibitors in the deicing compositions. Unfortunately, the addition of proteins to deicing solutions causes many problems with handling and stability characteristics of the solutions. Typically, the protein sources are difficult, if not impossible to get fully mixed with the other components of the deicing compositions. Further, any deicing composition that is made containing a protein component often forms precipitates and/or flocculates during storage prior to use and during use as well. If the proteins do not come completely out of solution to form a precipitate or flocculate, they still often form gels that cause gelling of the deicing composition and impair the ability to evenly apply and distribute the deicing compositions.

Thus, there exists a need for protein-containing deicing compositions with good handling and anticorrosive properties that maintain the ability to melt snow and ice from outdoor surfaces.

### SUMMARY OF THE INVENTION

In one embodiment, a deicing composition is disclosed that contains a deicing component, a corrosion inhibitor and a digested animal or vegetable protein. In an related embodiment, a deicing composition is described that contains a magnesium salt, a corrosion inhibitor, and a digested protein. A related deicing composition described herein contains a magnesium salt and a digested animal or vegetable protein.

In another embodiment, a deicing composition is disclosed that contains a magnesium salt, triethanol amine, and a digested animal or vegetable protein.

In another embodiment, a deicing composition is disclosed that has a pH between pH 5 and pH 9 and includes a magnesium salt, a corrosion inhibitor, and a digested protein. This deicing composition preferably has a pH between pH 6 and pH 8. Even more preferably, this deicing composition has a pH between pH 6.5 and pH 7.5. Preferred embodiments of this deicing composition have a pH of about 6.5 or about 7.5.

Another embodiment is a liquid corrosion inhibiting composition that has a pH between pH 4 and pH 11 and includes triethanolamine and a protein. Preferably, this corrosion inhibiting composition has a pH of about pH 10. The protein component is preferably a digested animal protein or a digested vegetable protein.

A related embodiment is a liquid corrosion inhibiting composition having a pH between pH 4 and pH 6 and including a digested animal protein. This corrosion inhibiting composition may have a pH between pH 4.5 and pH 5. Preferably, this composition has a pH of about pH 4.7 or about pH 4.8.

A similar embodiment is a liquid corrosion inhibiting composition having a pH between pH 4 and pH 6 and including a digested vegetable protein. This corrosion inhibiting composition may have a pH between pH 4.5 and pH 5. Preferably, this composition has a pH of about pH 4.7 or about pH 4.8.

### DETAILED DESCRIPTION OF THE INVENTION

The deicing and corrosion-inhibiting compositions disclosed herein include deicing components, corrosion inhibitors and proteins in proportions effective to melt ice and snow while minimizing or eliminating corrosive degradation of metal surfaces that come in contact with these compositions. These compositions contain fully- or partially-digested animal or vegetable protein components. In another aspect, the deicing compositions contain protein components that have been neutralized. The proteins used in these aspects of the present invention reduce the corrosive properties of other deicing components and have additive effects to any corrosion inhibitors included in deicing composition, in addition to improving the handling and stability of the compositions.

Deicing components suitable for use in the present invention include, but are not limited to, alkali metal or alkaline earth metal chlorides, metal sulfates, phosphates, nitrates, amides, alcohols, glycols, long-chain amines, ammonium sulfate, ammonium nitrate, ammonium chloride, urea, glycerol, potassium carbonate, potassium bicarbonate, potassium acetate, sodium chloride, calcium chloride, magnesium salts including magnesium chloride, calcium formate, calcium magnesium acetate, and sodium dichromate. These deicing components preferably constitute between about 20% and about 30% of the final deicing compositions of the present invention. All composition percentages given herein are on a weight basis. Preferably, the deicing components constitute between about 15% and about 40% of the deicing compositions. More preferably, the deicing components constitute between about 20% and about 35% of the deicing compositions. More preferably, the deicing components constitute between about 25% and about 30% of the deicing compositions. More preferably, magnesium chloride is used as the deicing component in an amount sufficient to provide between about 23% and about 30% of the final deicing compositions of the present invention. Most preferably, magnesium chloride is used as the deicing component in an amount sufficient to provide about 29% of the final deicing composition.

Corrosion inhibitors suitable for use in the present invention include, but are not limited to zinc, antimony, manganese, cadmium, nickel, cobalt, tin, aluminum, amines such as triethanol amine (TEA), carbohydrates, gluconates, acetates and citrates. The amount of the corrosion inhibitor to be used in the deicing compositions of the present invention can vary widely depending on the strength of the corrosion inhibitor as well as cost or handling concerns associated with the different inhibitors. Typically, the corrosion inhibitor additive of the present invention constitutes between about 0.01% and about 1.0%, more preferably between about 0.05% and about 0.5%, and most preferably between about 0.25% and about 0.5% of the deicing compositions of the present invention.

The protein component of the present invention may be obtained from many sources. Inexpensive sources of protein suitable for use in deicing compositions of the present invention can be found in waste streams or byproducts of agricultural or livestock processes. Pork and beef hides and hooves are examples of useful sources of inexpensive protein for use in the deicing compositions of the present invention. Additionally, grain (e.g., corn and wheat) and forage proteins are useful in the producing the protein additives of the deicing components of the present invention. Optionally, these protein additives may first be processed to neutralize the pH before partially or fully digesting them and combining them with any deicing and/or anti-corrosion chemicals. This digestion and neutralization makes the protein component of the deicing composition easier to mix with water and other components of deicing compositions. Further, this protein processing greatly improves the handling characteristics of the final deicing composition by reducing or eliminating physical characteristics previously seen with deicing compositions that included protein components. For example, the deicing compositions of the present invention that contain a neutralized or at least partially digested protein source are resistant to precipitation, flocculation and gelling that often occurs in protein-containing deicing compositions of the prior art. This results in deicing compositions having greater stability for prolonged periods between production and application on snow or ice-covered surfaces.

The pH of these deicing compositions as well as the pH of the protein components therein plays a role in the stability, appearance, odor and handling characteristics of these products. Typically, the final deicing compositions have a pH range between pH 5 and pH 9. This pH range enhances the protein solubility in the deicing and corrosion-inhibiting compositions while minimizing undesirable odor and color of the final compositions to be spread on icy surfaces.

The protein component of the present invention is typically a liquid component having protein in solution, being a stable suspension of protein, or a combination thereof. As used herein, the term protein solution refers to such a liquid protein component. As used herein, reference to a stable suspension means a suspension that maintains a uniform dispersion of the protein under typical storage conditions for at least about a month, more preferably three months, more preferably six months and more preferably, at least one year. Typically, a solid protein material is processed by mixing it with water and heating the mixture to a temperature of between about 40° C. and about 82° C. The liquid protein source can then be processed by neutralization and/or digestion of the protein in the protein solution. The protein may be neutralized or adjusted to a pH of between about pH 4 and about pH 11. Preferably, the pH of the protein component is stabilized between about pH 4 and about pH 6. Preferably, the pH of the protein component is stabilized between about pH 4.5 and about pH 5. More preferably, the pH of the protein component is stabilized at pH 4.7 or pH 4.8. As used herein, reference to adjusting and/or neutralizing the pH refers to determining the pH of a solution and if it is not within desired or selected limits, adjusting the pH to be within the limits. This neutralization can be performed by any methods commonly known in the art. For example, if the protein source is initially too alkaline, the pH can be lowered close to the desired pH by the addition of a weak acid. Conversely, if the protein source is initially too acidic, a weak base can be added to adjust the pH of the protein source to the desired pH. Protein solutions of the present invention typically have between about 10% and about 25% protein.

The protein source can also be partially or fully digested by the addition of one or more proteolytic enzymes. Preferably, nonspecific proteolytic enzymes such as trypsin, chymotrypsin, or the like are used to partially or fully digest the protein prior to the addition of the protein source to other components of the deicing compositions of the present invention. Preferably, the proteolytic enzyme used for the digestion is Alcalase® (Novozymes). The proteolytic enzyme is added to the protein source and incubated for a time sufficient to partially or fully digest the protein present in the protein source. The incubation is typically conducted between about 20° C. and about 60° C. Preferably, the incubation is conducted at room temperature. The incubation may continue for an indefinite period of time as there is no need to stop the digestion reaction prior to adding other components of the deicing compositions nor is there any need to separate or remove the proteolytic enzymes from the digested protein source prior to use in the deicing compositions.

The proteolytic enzyme may also be added directly to the deicing composition following the addition of the protein if the deicing composition includes components in which the proteolytic enzyme retains activity. In this way, the components of the deicing composition are combined and mixed and the proteolytic enzyme is added and allowed to digest the protein contained within the composition as long as the protein remains active. However, it may be difficult to first mix the undigested protein source with the other deicing composition components. For this reason, the preferred method is the partial or full proteolysis of the proteins prior to the addition of the protein source to the deicing composition.

Hydrolyzed proteins may also be purchased commercially for use in the deicing compositions of the present invention although the cost of these commercial sources makes them expensive for use and distribution on a large scale.

The processing of the protein component can be performed in any order although, when conducted, the neutralization processing is preferably performed first as most proteolytic enzymes have a higher digestive activity at the more neutral pH.

The protein component of the deicing compositions is typically present in an amount constituting between about 0.001% and about 1% of the final composition and more preferably, between about 0.01% and about 0.15%.

Optionally, the deicing compositions of the present invention may also include a carbohydrate component. The addition of the carbohydrate component lowers the temperature at which the deicing compositions of the present invention are effective in aiding the removal of snow or ice. Thus, the addition of the carbohydrate component is preferred in circumstances in which the temperature of the snow or ice covered surface to which the deicing composition is to be applied is much lower than about −1° C. or −6° C. Preferably, this carbohydrate component is a complex carbohydrate such as processed corn, sugar beets, processed forage crops (e.g., alfalfa) or soybeans. A preferred source of the complex carbohydrate is a carbohydrate mixture obtained from corn by soaking whole grain corn in water, milling and processing to remove starch, followed by heat and acid processes to convert starches to carbohydrates.

In a preferred embodiment of the present invention, the deicing composition contains an aqueous MgCl₂ deicing component and a corrosion inhibitor package containing TEA, protein and water. This embodiment of the invention is preferably produced by forming a corrosion inhibitor package containing between about 30% and about 60% by weight TEA, and between about 1% and about 15% by weight protein, with the remainder water. A separate stock MgCl₂ solution is then formed which contains between about 20% and about 35%, preferably between about 26% and about 30%, by weight MgCl₂ in water. The deicing composition is then formed by mixing about 1 part of the corrosion inhibitor package with about 99 parts of the MgCl₂ stock solution.

Another preferred embodiment of the present invention is a deicing composition containing a MgCl₂ deicing component, a carbohydrate component and a corrosion inhibitor package containing TEA, protein and water. This deicing composition is prepared by combining a complex carbohydrate mixture with the corrosion inhibitor package and the MgCl₂ stock solutions described above. Preferably, the final deicing composition contains between about 85% to about 90% of the MgCl₂ stock solution, between about 0.1% to about 2% of the corrosion inhibitor package and between about 5% and about 15% of the complex carbohydrate mixture.

A further aspect of the present invention provides a process for making road surfaces free of snow and ice, in which compositions of the present invention are applied onto the road surfaces. The composition is preferably applied onto the road surface from a moving vehicle in an amount of sufficient to reduce snow and ice. The handling and application of the deicing compositions of the present invention is greatly improved by the neutralized and digested protein component of the deicing compositions. This treated protein component prevents gelling and precipitation of the deicing compositions in the distribution machinery or on the road surfaces. The application of these deicing components to the road surface may be repeated as often as desired. The compositions greatly reduce the damage to metallic surfaces resulting from corrosion that is typically seen with deicing chemicals.

The following Examples are provided to illustrate embodiments of the present invention and are not intended to limit the scope of the invention.

### EXAMPLES

### Example 1

A deicing composition is prepared as follows. A corrosion inhibitor component is prepared by making a between 45% and 80% by weight TEA solution in water and mixing HydroTriticum WAA, a protein-based product used in the personal care industry and available from Croda Chemical, resulting in 3% to 10% by weight WAA in the TEA solution. Add this corrosion inhibitor component to a magnesium chloride solution at between 0.25% to 1.0% of the finished product.

### Example 2

A deicing composition is prepared as follows. A corrosion inhibitor component is prepared by making a between 45% and 80% by weight TEA solution in water and mixing it with a protein source of animal byproducts such as hooves and horns. A granular form of the byproduct is obtained, usually a gelatin form, liquefied with water, pH adjusted and digested with enzymes. The resulting mixture has between 3% and 10% by weight of the protein solution in the TEA solution. Add this corrosion inhibitor component to a magnesium chloride solution at between 0.25% to 1.0% of the finished product.

### Example 3

A deicing composition is prepared as follows. A corrosion inhibitor component is prepared by making a between 45% and 80% by weight TEA solution in water and mixing it with a protein source of animal byproducts such as hides. A granular form of the byproduct is obtained, usually a gelatin form, liquefied with water, pH adjusted and digested with enzymes. The resulting mixture has between 3% and 10% by weight of the protein solution in the TEA solution. Add this corrosion inhibitor component to a magnesium chloride solution at between 0.25% to 1.0% of the finished product.

### Example 4

A deicing composition is prepared as follows. A corrosion inhibitor component is prepared by making a between 45% and 80% by weight TEA solution in water and mixing it with a protein source of a forage crop such as alfalfa. Raw, or green, alfalfa (either fresh from field or dried) is mixed with water and processed into a mulch that is acidified and centrifuged to extract liquid protein. The resulting mixture has between 3% and 10% by weight of the protein solution in the TEA solution. Add this corrosion inhibitor component to a magnesium chloride solution at between 0.25% to 1.0% of the finished product.

### Example 5

A deicing composition is prepared as follows. A corrosion inhibitor component is prepared by making a between 45% and 80% by weight TEA solution in water and mixing it with a protein source of corn or soybean. Corn or soybean protein is extracted by milling the whole grain, removing germ (oils) and by processing extract liquid proteins. The resulting mixture has between 3% and 10% by weight of the protein solution in the TEA solution. Add this corrosion inhibitor component to a magnesium chloride solution at between 0.25% to 1.0% of the finished product.

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the appended claims.

What is claimed is:

1. A deicing composition comprising:
a. a deicing component;
b. a corrosion inhibitor; and,
c. a digested animal or vegetable protein component.

2. A deicing composition consisting of:
a. a magnesium salt;
b. a corrosion inhibitor; and,
c. a digested protein.

3. A deicing composition comprising:
a. a magnesium salt; and
b. a digested animal or vegetable protein.

4. A deicing composition comprising:
a. a magnesium salt;
b. triethanol amine; and,
c. a digested animal or vegetable protein.

5. A deicing composition comprising:
a. a magnesium salt;
b. a corrosion inhibitor; and,
c. a digested protein;
wherein, the deicing composition has a pH between pH 5 and pH 9.

6. The deicing composition of claim 5, wherein the pH of the deicing composition is between pH 6 and pH 8.

7. The deicing composition of claim 5, wherein the pH of the deicing composition is between pH 6.5 and pH 7.5.

8. The deicing composition of claim 5, wherein the pH of the deicing composition is about pH 6.5.

9. The deicing composition of claim 5, wherein the pH of the deicing composition is about pH 7.5.

10. A liquid corrosion inhibiting composition, comprising triethanolamine and a protein, wherein the pH of the composition is between pH 4 and pH 11.

11. The liquid corrosion inhibiting composition of claim 10, wherein the pH of the composition is about pH 10.

12. The liquid corrosion inhibiting composition of claim 10, wherein the protein is at least one of a digested animal protein and a digested vegetable protein.

13. A liquid corrosion inhibiting composition, comprising a digested animal protein, wherein the pH of the composition is between pH 4 and pH 6.

14. The liquid corrosion inhibiting composition of claim 13, wherein the pH of the composition is between pH 4.5 and pH 5.

15. The liquid corrosion inhibiting composition of claim 13, wherein the pH of the composition is about pH 4.7.

16. The liquid corrosion inhibiting composition of claim 13, wherein the pH of the composition is about pH 4.8.

17. A liquid corrosion inhibiting composition, comprising a digested vegetable protein, wherein the pH of the composition is between pH 4 and pH 6.

18. The liquid corrosion inhibiting composition of claim 17, wherein the pH of the composition is between pH 4.5 and pH 5.

19. The liquid corrosion inhibiting composition of claim 17, wherein the pH of the composition is about pH 4.7.

20. The liquid corrosion inhibiting composition of claim 17, wherein the pH of the composition is about pH 4.8.
